(19) United States
(12) Patent Application Publication
(10) Pub. No.: US 2025/0282147 A1
(43) Pub. Date: Sep. 11, 2025

(54) LIQUID DISCHARGE APPARATUS AND LIQUID DISCHARGING METHOD

(71) Applicants: Hitoshi Kida, KANAGAWA (JP); Ryuji Higashi, KANAGAWA (JP); Tomomasa Kajita, KANAGAWA (JP)

(72) Inventors: Hitoshi Kida, KANAGAWA (JP); Ryuji Higashi, KANAGAWA (JP); Tomomasa Kajita, KANAGAWA (JP)

(73) Assignee: Ricoh Company, Ltd., Tokyo (JP)

(21) Appl. No.: 19/055,974

(22) Filed: Feb. 18, 2025

(30) Foreign Application Priority Data
Mar. 11, 2024 (JP) 2024-036999

(51) Int. Cl. B41J 2/175; B41J 2/14

(52) U.S. Cl. CPC B41J 2/17596; B41J 2/1433; B41J 2002/14411; B41J 2202/05; B41J 2202/11

(57) ABSTRACT

A liquid discharge apparatus includes a liquid chamber including a nozzle plate having a nozzle hole, a supply unit to supply a liquid to the liquid chamber, a valve disposed in the liquid chamber, and a valve conveyor to move the valve. When the liquid is to be discharged and when the liquid is not to be discharged, the liquid is supplied from the liquid chamber to the nozzle hole. An amount of the liquid to be supplied to the nozzle hole when the liquid is not to be discharged is smaller than an amount of the liquid to be supplied to the nozzle hole when the liquid is to be discharged.

### CROSS-REFERENCE TO RELATED APPLICATION

This patent application is based on and claims priority pursuant to 35 U.S.C. § 119 (a) to Japanese Patent Application No. 2024-036999, filed on Mar. 11, 2024, in the Japan Patent Office, the entire disclosure of which is hereby incorporated by reference herein.

### BACKGROUND

### Technical Field

The present disclosure relates to a liquid discharge apparatus and a method of discharging liquid.

### Background Art

In liquid discharge apparatuses in which valves open and close, pressurized liquid that is supplied to a liquid chamber is discharged as the nozzle holes that are formed on the liquid chamber are opened by the movement of valves, and the liquid is not discharged when the nozzle holes are closed by the movement of the valves.

In order to reduce the ejection abnormality, for example, vibration is given to the liquid levels inside the nozzle holes when liquid is not to be discharged. By so doing, the thickened liquid is stirred in the liquid chamber.

### SUMMARY

The present disclosure described herein provides a liquid discharge apparatus and a method of discharging a liquid. The liquid discharge apparatus includes a liquid chamber including a nozzle plate having a nozzle hole, a supply unit to supply a liquid to the liquid chamber, a valve disposed in the liquid chamber, and a valve conveyor to move the valve. When the liquid is to be discharged and when the liquid is not to be discharged, the liquid is supplied from the liquid chamber to the nozzle hole. An amount of the liquid to be supplied to the nozzle hole when the liquid is not to be discharged is smaller than an amount of the liquid to be supplied to the nozzle hole when the liquid is to be discharged. The method includes supplying the liquid from the liquid chamber to the nozzle hole of the nozzle plate when the liquid is to be discharged and when the liquid is not to be discharged.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a schematic sectional view of a liquid discharge apparatus according to a first embodiment, illustrating its overall configuration.

FIG. 2 is a magnified view of a nozzle hole and elements around the nozzle hole, where the nozzle hole is almost completely closed by a valve.

FIG. 3 is a magnified view of a nozzle hole and elements around the nozzle hole, where the nozzle hole is not completely closed by a valve.

FIG. 4 is a block diagram illustrating a functional configuration of a controller provided for a liquid discharge apparatus, according to a first embodiment.

FIG. 5 is a diagram illustrating the driving voltage of a valve conveyor provided for a liquid discharge apparatus according to a first embodiment.

FIG. 6 is a diagram illustrating how an end face of a valve moves according to the driving voltage illustrated in FIG. 5.

FIG. 7 is a schematic perspective view of a valve provided for a liquid discharge apparatus according to a first modification of the first embodiment.

FIG. 8 is a schematic sectional view of a valve provided for a liquid discharge apparatus according to a second modification of the first embodiment.

FIG. 9 is a schematic sectional view of a valve provided for a liquid discharge apparatus according to a third modification of the first embodiment.

FIG. 10 is a schematic perspective view of a nozzle plate provided for a liquid discharge apparatus according to a fourth modification of the first embodiment.

FIG. 11 is a schematic sectional view of a nozzle plate provided for a liquid discharge apparatus according to a fifth modification of the first embodiment.

FIG. 12 is a schematic view of a nozzle plate provided for a liquid discharge apparatus according to a sixth modification of the first embodiment.

FIG. 13 is a schematic sectional view of a liquid discharge apparatus according to a second embodiment, where liquid is not discharged.

FIG. 14 is a schematic sectional view of a liquid discharge apparatus according to the second embodiment, where liquid is discharged.

FIG. 15 is a schematic diagram illustrating a configuration of an applicator according to a third embodiment.

FIG. 16 is a diagram illustrating a first example of the arrangement of an applicator on an object, according to a third embodiment.

FIG. 17 is a diagram illustrating a second example of the arrangement of an applicator on an object, according to the third embodiment.

FIG. 18 is a first schematic sectional view of a nozzle plate provided for a liquid discharge apparatus according to a seventh modification.

FIG. 19 is a second schematic sectional view of a nozzle plate provided for a liquid discharge apparatus according to a seventh modification.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-programmable gate arrays (FPGAs), computers, or the like. These terms may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

A liquid discharge apparatus and a method of discharging liquid are described below with reference to the accompanying drawings. A liquid discharge apparatus and a method of discharging a liquid according to embodiments of the present disclosure are described below to implement the technical ideas, and no limitation is indicated to the embodiments of the present disclosure given below. For example, the size, material, and shape of components and the relative positions of the arranged components are given by way of example in the following description, and the scope of the present disclosure is not limited thereto unless particularly specified. For example, the size of these elements and the relative positions of these elements may be exaggerated for purposes of illustration in the drawings. In the description given below with reference to the drawings, identical or similar names or reference signs denote like elements, and overlapping description may be simplified or omitted as appropriate.

The directions that the X-axis and the Y-axis indicate are applicable to the drawings referred to in the following description. A direction in which the X-axis extends is referred to as the X-axis direction, and a direction in which the Y-axis extends is referred to as the Y-axis direction. The direction that is indicated by an arrow in the X-axis direction is referred to as a +X-axis direction, and the direction opposite to the +X-axis direction is referred to as a −X-axis direction. The direction that is indicated by an arrow in the Y-axis direction is referred to as a +Y-axis direction, and the direction opposite to the +Y-axis direction is referred to as a −Y-axis direction. In the description given below, it is assumed that the direction of the normal to the nozzle plate provided for the liquid discharge apparatus is parallel to the Y-axis direction. These expressions that indicate specific directions are merely used to indicate a relation such as a relative position, orientation, and direction, and it is not necessary for those expressions to be consistent with the relation in use.

In order to avoid complication in the drawings, a schematic diagram in which the illustration of some parts or members is omitted may be used, or an end view that merely illustrates a sectional view may be used. The parallelism may include an error of ±10 degrees or less with respect to 0 degrees. The orthogonality may include an error of ±10 degrees or less with respect to 90 degrees. The arrangement is not limited to a case of direct contact, and includes a case of indirect disposition such as contact through another member.

### First Embodiment

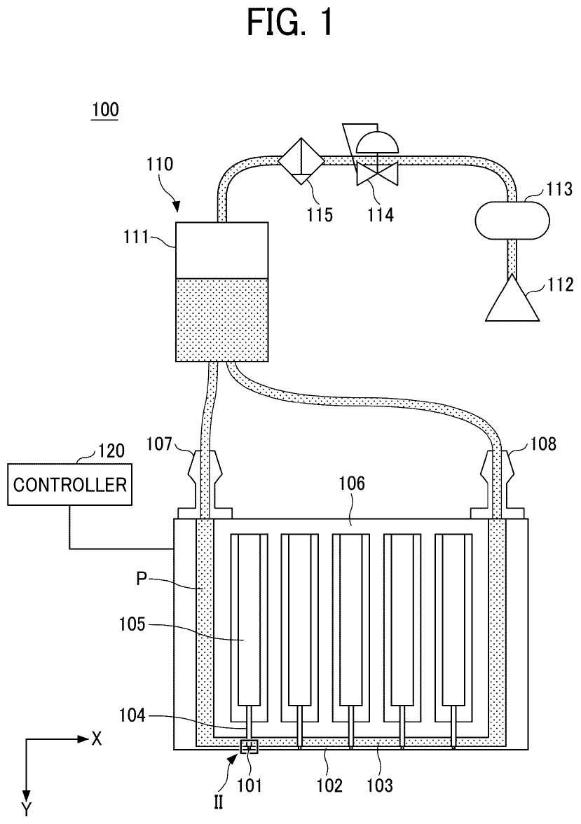

The configuration or structure of the liquid discharge apparatus 100 according to the first embodiment is described below with reference to FIG. 1 to FIG. 3.

FIG. 1 is a schematic sectional view of the liquid discharge apparatus 100 according to the first embodiment, illustrating its overall configuration.

FIG. 1 illustrates a cross section of the liquid discharge apparatus 100 including a plurality of nozzle holes 101 provided for the liquid discharge apparatus 100.

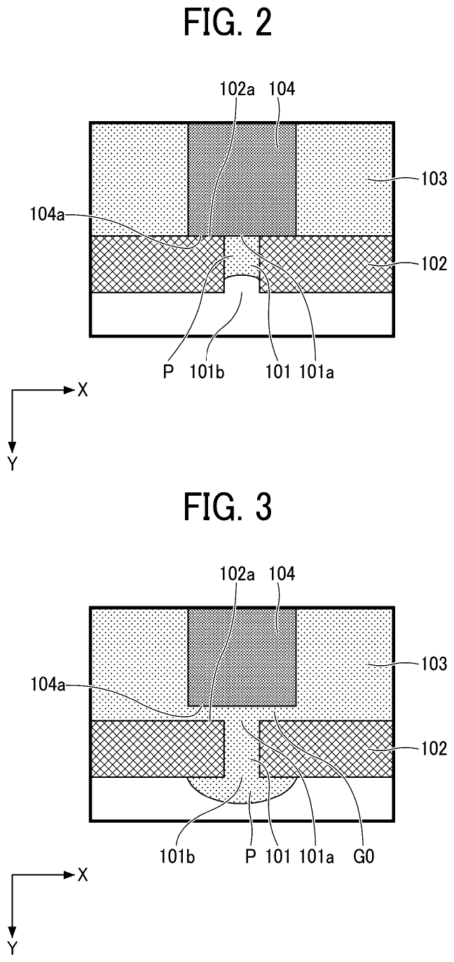

FIG. 2 is a magnified view of the nozzle hole 101 and elements around the nozzle hole 101, where the nozzle hole 101 is almost completely closed by the valve 104.

FIG. 3 is a magnified view of the of nozzle hole 101 and elements around the nozzle hole 101, where the nozzle hole 101 is not completely closed by the valve 104.

FIG. 2 and FIG. 3 are magnified views of a region corresponding to the region II in FIG. 1.

The liquid discharge apparatus 100 includes a liquid chamber 103 including a nozzle plate 102 having a nozzle hole 101 through which liquid is discharged, a supply unit 110 that supplies a pressurized liquid P to the liquid chamber 103, a valve 104 provided for the liquid chamber 103, and a valve conveyor 105 to move the valve 104. As illustrated in FIG. 1, the liquid discharge apparatus 100 includes a controller 120 that controls the movement of the valve 104 by the valve conveyor 105, and a frame 106 to which an end of the valve conveyor 105 that does not face the valve 104 is coupled. The liquid discharge apparatus 100 further includes a supply port 107 through which the liquid P is supplied from the supply unit 110 to the liquid chamber 103, and a discharge port 108 through which the liquid P in the liquid chamber 103 is discharged to the supply unit 110.

In the liquid discharge apparatus 100, the pressurized liquid P that is supplied to the liquid chamber 103 by the supply unit 110 is discharged as the nozzle holes 101 formed on the liquid chamber 103 are opened by the movement of the valves 104, and is not discharged when the nozzle holes 101 are closed by the movement of the valves 104. The liquid discharge apparatus 100 is a liquid discharge apparatus in which valves open and close. In the liquid discharge apparatus 100, the liquid P is discharged through the nozzle hole 101 from the inside to the outside of the liquid chamber 103 in a direction parallel to the Y-axis direction or a direction of the normal to the nozzle plate 102.

As illustrated in FIG. 1, the nozzle holes 101 are arrayed on the nozzle plate 102 in the X-axis direction. The liquid chambers 103, which correspond to the nozzle holes 101, are linked to each other in the X-axis direction to form one common chamber. The liquid P that is supplied from the supply unit 110 flows through the common chamber composed of the liquid chambers 103. The liquid discharge apparatus 100 discharges the liquid P flowing in the common chamber from the nozzle holes 101 on an individual basis.

In such liquid discharge apparatuses where valves open and close, as illustrated in FIG. 2, if an end 101a of the nozzle hole 101 facing the valve 104 is blocked and closed by the valve 104 when the liquid P is not to be discharged, the liquid P may remain inside the nozzle hole 101. The liquid P in the nozzle hole 101 illustrated in FIG. 2 is the liquid remaining inside the nozzle hole 101. In addition to the end 101a, the nozzle hole 101 has an end 101b on the other side that is open to the atmosphere. For this reason, when the nozzle hole 101 is left for a long time, the liquid P that remains in the nozzle hole 101 is exposed to the atmosphere and is dried. Due to such drying, the liquid P in the nozzle hole 101 may be thickened or may adhere to, for example, the inner wall of the nozzle hole 101. Due to such thickening of the liquid P or the adhesion of the liquid P to the nozzle hole 101, when the liquid P is discharged from the nozzle hole 101 for the next time, discharge abnormality may take place in which the liquid P is not discharged or the liquid P is turned and discharged.

For example, in the related art, in order to reduce the chances of abnormal discharge, vibration is given to the liquid levels inside the nozzle holes when liquid is not to be discharged. By so doing, the thickened liquid is stirred in the liquid chamber. However, in such liquid discharge apparatuses where valves open and close, the liquid inside the liquid chamber is pressurized. For this reason, when liquid is not to be discharged, vibration cannot be given to the liquid levels inside the nozzle holes. For this reason, in such liquid discharge apparatuses where valves open and close, the thickened liquid cannot be stirred in the liquid chamber, and discharge abnormality cannot be reduced.

In the liquid discharge apparatus 100, when the liquid P is to be discharged and when the liquid P is not to be discharged, the liquid P is supplied from the liquid chamber 103 to the nozzle holes 101. The amount of the liquid P to be supplied to the nozzle holes 101 when the liquid P is not to be discharged is smaller than the amount of the liquid P to be supplied to the nozzle holes 101 when the liquid P is to be discharged.

For example, as illustrated in FIG. 3, in the liquid discharge apparatus 100, even when the liquid P is not discharged, the end 101a of the nozzle hole 101 is not completely closed by the end face 104a of the valve 104 that face the nozzle plate 102 such that the gap G0 appears between the valve 104 and the nozzle plate 102. As the gap G0 is made, the liquid P can flow through the gap G0, and the liquid P is supplied from the liquid chamber 103 to the nozzle holes 101. From another viewpoint, in the liquid discharge apparatus 100, the gap G0 is made to decrease the degree of hermetically sealing of the nozzle hole 101 by the valve 104, and the liquid P can be supplied to the nozzle holes 101 even when the liquid P is not to be discharged.

The gap G0 when the liquid P is not to be discharged is narrower than the gap between the valve 104 and the nozzle plate 102 when the liquid P is to be discharged. Accordingly, the amount of the liquid P to be supplied to the nozzle holes 101 when the liquid P is not to be discharged becomes smaller than the amount of the liquid P to be supplied to the nozzle holes 101 when the liquid P is to be discharged, and the liquid P is not discharged from the nozzle holes 101.

In the liquid discharge apparatus 100, when the liquid P is not to be discharged, the liquid P is supplied from the liquid chamber 103 to the nozzle holes 101, but the liquid P is not discharged from the nozzle holes 101. Accordingly, when the liquid P remaining in the nozzle holes 101 is exposed to the outside air and dried, the liquid P that is fresh is supplied from the liquid chamber 103 to the nozzle holes 101. Accordingly, the chances of the liquid P, which remains in the nozzle holes 101, thickening or adhering to, for example, the inner walls of the nozzle holes 101 can be reduced. Accordingly, when the liquid P is discharged from the nozzle holes 101 again after a non-discharge period, the chances of discharge abnormality in which the liquid P is not discharged or the liquid P is turned and discharged can be reduced. When the liquid P is not discharged from the nozzle holes 101 in the present disclosure, the liquid P does not drip or leak out from the nozzle holes 101.

In the liquid discharge apparatus 100, as illustrated in FIG. 3, when the liquid P is not to be discharged, a part of the liquid P disposed in the nozzle hole 101 protrudes from the nozzle plate 102. Due to such a configuration, when the liquid P is not to be discharged, the liquid P is supplied from the liquid chamber 103 to the nozzle holes 101, but the liquid P is not discharged from the nozzle holes 101.

In the liquid discharge apparatus 100, the amount of the liquid P to be supplied to the nozzle holes 101 when the liquid P is not to be discharged varies depending on the physical properties of the liquid P or the environment near the nozzle holes. For example, the physical properties of the liquid P the viscosity or surface tension of the liquid P or the boiling point of the liquid P, and the environment near the nozzle holes is steam pressure near the nozzle holes. The amount of the liquid P to be supplied to the nozzle holes 101 when the liquid P is not to be discharged is changed according to the physical properties of the liquid P. Due to such a configuration, when the liquid P is not to be discharged, the liquid P is supplied from the liquid chamber 103 to the nozzle holes 101, but the liquid P is not discharged from the nozzle holes 101. Such a condition is achieved with high stability regardless of the physical properties of the liquid P. The amount of the liquid P to be supplied to the nozzle holes 101 when the liquid P is not to be discharged is changed according to the steam pressure near the nozzle holes. Due to such a configuration, when the liquid P is not to be discharged, the liquid P is supplied from the liquid chamber 103 to the nozzle holes 101, but the liquid P is not discharged from the nozzle holes 101. In a similar manner to the above, such a condition is achieved with high stability regardless of the environment near the nozzle holes.

Some components of the liquid discharge apparatus 100 or elements related to those components are described below in detail.

The liquid P is, for example, a liquid whose viscosity is greater than 10 millipascal-second (mPa·s), a liquid whose TI value indicating mechanical viscosity is greater than 1.3, a liquid whose solid matter is greater than 20 weight (wt) %, or a liquid that contains particles whose particle diameter is wider than 5 micrometers (μm). For example, particles contained in the liquid P are active-material particles such as ceramic particles, carbon particles, and lithium transition metal oxide.

The nozzle plate 102 is a plate-like component including, for example, a metallic material. The nozzle plate 102 makes up a part of the liquid chamber 103, and is arranged so as to face ends of the valves 104. The nozzle hole 101 is a through hole formed on the nozzle plate 102 to penetrate in a direction of the normal to the nozzle plate 102. The top face 102a of the nozzle plate 102 is a top face of the nozzle plate 102 that faces the valve 104.

The valves 104 are a plurality of stick-like members each of which extends in the Y-axis direction. The ends of the valves 104 on the +Y side are arranged so as to be accommodated inside the liquid chamber 103. The valve 104 includes, for example, a metallic material. An end of the valve 104 that faces the nozzle plate 102 may be prepared as a member separate from the body of the valve 104, and the separate member and the body of the valve 104 may be bonded together to make up the valve 104.

The multiple valves 104 are paired with the nozzle holes 101 on a one-on-one basis, and are movable in the Y-axis direction. A part of each one of the multiple valves 104 on the +Y side is inserted into the liquid chamber 103. The valve 104 opens and closes the nozzle hole 101 by the movement of the valve 104. The valve conveyor 105 moves the valve 104 in the Y-axis direction according to the applied voltage. Due to such a configuration, it is switchable between a state in which the nozzle hole 101 is open as the end face 104a of the valve 104 does not block the end 101a of the nozzle hole 101 and a state in which the nozzle hole 101 is closed as the end face 104a of the valve 104 blocks the end 101a of the nozzle hole 101.

The valve conveyor 105 includes a piezoelectric element that expands and contracts in response to an applied voltage. Such a piezoelectric element of the valve conveyor 105 may be, for example, a vertically-displacing piezoelectric element of d33 mode. The piezoelectric element of the valve conveyor 105 expands and contracts in the Y-axis direction in response to the applied voltages. The material of the piezoelectric element is, for example, lead zirconate titanate (PZT). The piezoelectric element of the valve conveyor 105 is a multi-layered piezoelectric element in which a plurality of piezoelectric elements are stacked on top of each other in the Y-axis direction in order to increase the amount of displacement caused by the expansion and contraction. The valve conveyor 105 illustrated in FIG. 1 moves the valve 104 in the Y-axis direction as the piezoelectric element expands and contracts in accordance with the applied voltage.

As the piezoelectric element of the valve conveyor 105 contract in the Y-axis direction in response to the applied voltages, the valve 104 moves in the −Y-axis direction, and the end face 104a of the valve 104 is separated from the end 101a of the nozzle hole 101 to open the nozzle hole 101. As the piezoelectric element in the valve conveyor 105 expands in the Y-axis direction in response to the applied voltages, the valve 104 moves in the +Y-axis direction and the end face 104a of the valve 104 blocks the end 101a of the nozzle hole 101 to close the nozzle hole 101.

As illustrated in FIG. 1, the supply unit 110 includes a liquid storage 111, an air compressor 112, an air tank 113, a regulator 114, and an air filter 115. The supply unit 110 keeps the compressed air produced by the air compressor 112 in the air tank 113 on a temporary basis to maintain the pressure. Subsequently, the regulator 114 controls the supply unit 110 to reduce the pressure of the compressed air to a level of pressure required to discharge the liquid P, and controls the air filter 115 to remove, for example, foreign matter, moisture, or oil content. After that, the regulator 114 controls the supply unit 110 to increase the pressure inside the liquid storage 111. The liquid P whose pressure is increased by the supply unit 110 is supplied to the liquid chamber 103 through the supply port 107.

As the liquid P is pressurized by the supply unit 110, the liquid P can be discharged to the outside of the liquid chamber 103 through the nozzle hole 101 when the nozzle hole 101 is opened by the valve 104. The liquid P is not discharged when the nozzle hole 101 is closed by the valve 104.

The valve conveyor 105 illustrated in FIG. 1 includes a piezoelectric element. However, no limitation is indicated thereby. For example, the valve conveyor 105 may include at least one of an electromagnet that generates a magnetic field in response to an applied voltage, an air cylinder that converts compressed-air energy into a linear motion in response to an applied voltage, a motor actuator that is driven in response to an applied voltage, or a hydraulic mechanism that generates a hydraulic pressure in response to an applied voltage.

The liquid discharge apparatus 100 may be provided with the valve conveyor 105 that includes a piezoelectric element of d31 mode. The relation between the magnitude of the applied voltage and the expansion and contraction when such a piezoelectric element of d31 mode is adopted is completely different from the relation when a piezoelectric element of d33 mode is adopted. For example, the valve conveyor 105 may have the nozzle hole 101 at one end, and may include a hollow nozzle housing that has an inlet through which the liquid P is injected near the nozzle hole 101, a piezoelectric element that is built in the nozzle housing and expands and contracts in response to the external application of a driving voltage, a valve that opens and closes a discharge orifice, a reverse spring mechanism arranged between the valve and the piezoelectric element, a sealing member fit to the valve to prevent the ink from flowing into the area on the piezoelectric element side, and a pair of lead wires coupled to the electrodes of the piezoelectric element to apply a voltage.

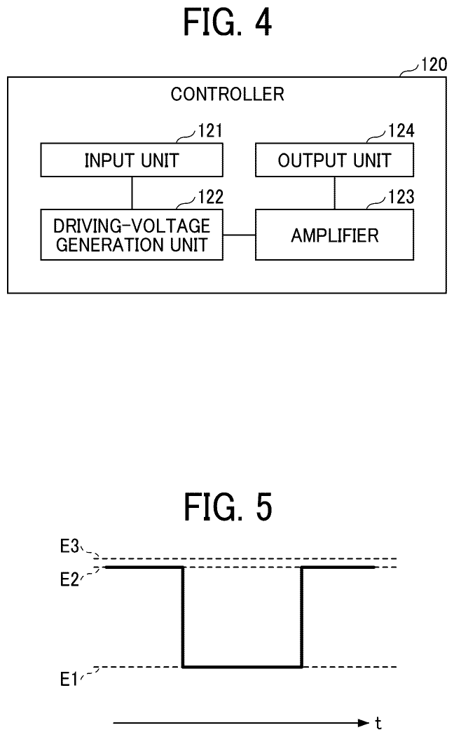

FIG. 4 is a block diagram illustrating a functional configuration of the controller 120.

FIG. 5 is a diagram illustrating the driving voltage of the valve conveyor 105.

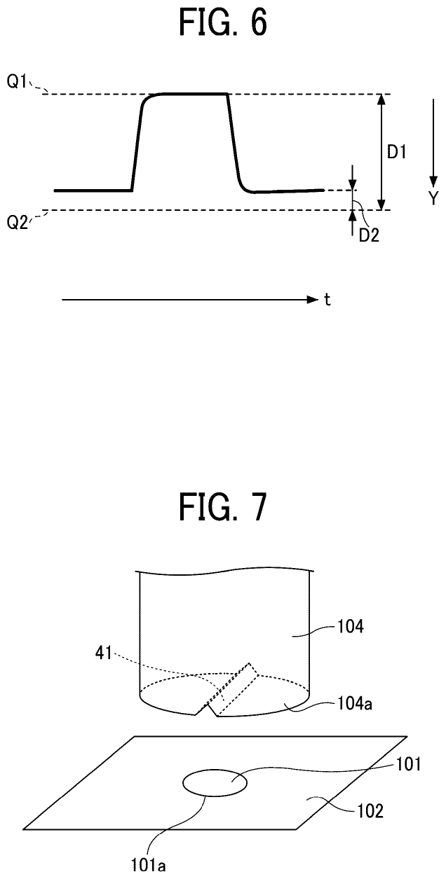

FIG. 6 is a diagram illustrating how the end face 104a of the valve 104 moves according to the driving voltage illustrated in FIG. 5.

In FIG. 5 and FIG. 6, the horizontal axis indicates time. In FIG. 5, the vertical axis indicates the voltage value of the driving voltage. The vertical axis in FIG. 6 indicates the position of the end face 104a of the valve 104 in the Y-axis direction. In FIG. 5 and FIG. 6, the times on the horizontal axis are matched. The position of the valve 104 illustrated in FIG. 6 varies according to the voltage value of the driving voltage illustrated in FIG. 5. In FIG. 5 and FIG. 6, the voltage value of the driving voltage and the position of the end face 104a have a substantially linear relation. Such a substantially linear relation indicates that those factors are in a linear relation as a whole, and includes a time-lag of the positional change of the end face 104a in response to application of driving voltage and deviations from complete linearity such as errors in linearity and hysteresis.

The controller 120 illustrated in FIG. 4 includes an input unit 121, a driving-voltage generation unit 122, an amplifier 123, and an output unit 124. Such functions may be implemented by an electric circuit, or some of or all of those functions may be implemented by software or a central processing unit (CPU). These functions may be implemented by a plurality of circuits or a plurality of CPUs. The controller 120 generates, according to data input by the driving-voltage generation unit 122 through the input unit 121, a driving voltage to drive the valve conveyor 105 to open and close the nozzle hole 101 by the valve 104. The controller 120 amplifies the driving voltage generated by the driving-voltage generation unit 122 by the amplifier 123, and then outputs the amplified driving voltage to the valve conveyor 105 through the output unit 124.

The controller 120 outputs the waveform of the driving voltage, which is generated by the driving-voltage generation unit 122 and amplified by the amplifier 123, to the liquid discharge apparatus 100. By so doing, the driving voltage that varies over time is supplied to the valve conveyor 105.

In the liquid discharge apparatus 100, the controller 120 uses the movement of the valve 104 by the valve conveyor 105 to switch between a first mode used to discharge the liquid P and a second mode used not to discharge the liquid P. In the first mode, the end face 104a of the valve 104 is separate the top face 102a of the nozzle plate 102 by a first distance D1. A position Q2 in FIG. 6 corresponds to the position of the top face 102a of the nozzle plate 102 in the Y-axis direction. In the second mode, the end face 104a of the valve 104 is separate from the top face 102a of the nozzle plate 102 by a second distance D2 shorter than the first distance D1. In the second mode of the liquid discharge apparatus 100, the liquid P is supplied from the liquid chamber 103 to the nozzle holes 101 through the gap between the end face 104a of the valve 104 and the top face 102a of the nozzle plate 102.

More specific description is given below. When a first voltage E1 is applied to the valve conveyor 105, the piezoelectric element of the valve conveyor 105 contracts, and the end face 104a of the valve 104 moves in the −Y-axis direction. Accordingly, the end face 104a is separated from the end 101a of the nozzle hole 101 to open the nozzle hole 101. As the nozzle hole 101 opens, the liquid P is discharged from the nozzle holes 101. When a third voltage E3, which is higher than the first voltage E1, is applied to the valve conveyor 105, the piezoelectric element of the valve conveyor 105 expands, and the end face 104a of the valve 104 moves in the +Y-axis direction. As a result, the end face 104a of the valve 104 almost completely blocks the end 101a of the nozzle hole 101 to close the nozzle hole 101. As the nozzle hole 101 is closed, the liquid P is not discharged.

In the second mode of the liquid discharge apparatus 100, a second voltage E2, which is greater than the first voltage El and smaller than the third voltage E3, is applied to the valve conveyor 105. In such cases, the end face 104a of the valve 104 does not completely block the end 101a of the nozzle hole 101, and the gap G0 appears as illustrated in FIG. 3. As the nozzle hole 101 is closed, the liquid P is not discharged. In other words, in the second mode, the liquid P is supplied from the liquid chamber 103 to the nozzle holes 101, but the liquid P is not discharged from the nozzle holes 101. In the second mode of the liquid discharge apparatus 100, the liquid P is supplied from the liquid chamber 103 to the nozzle holes 101 through the gap G0 between the end face 104a of the valve 104 and the top face 102a of the nozzle plate 102.

It is desired that the second distance D2 be shorter as the degree of the pressure applied to the liquid P is higher. When the length of the gap G0 in the Y-axis direction is consistent, the amount of the liquid P supplied from the liquid chamber 103 to the nozzle holes 101 increases as the degree of the pressure applied to the liquid P is higher. When the amount of the liquid P supplied from the liquid chamber 103 to the nozzle holes 101 increases to an excessive degree, the liquid P may leak out or drip from the nozzle holes 101. The second distance D2 is shortened as the degree of the pressure applied to the liquid P is higher, so as to prevent the liquid P from leaking out or drips from the nozzle holes 101.

Some modifications of the liquid discharge apparatus 100 are described below.

### First Modification

FIG. 7 is a schematic perspective view of the valve 104 provided for the liquid discharge apparatus 100 according to a first modification of the first embodiment.

More specifically, FIG. 7 illustrates the end face 104a of the valve 104 and the nozzle hole 101 and nozzle plate 102 that face the end face 104a.

In the liquid discharge apparatus 100 according to the first modification, the first groove 41 is arranged on the end face 104a of the valve 104. In the liquid discharge apparatus 100 according to the first modification, when the liquid P is not discharged, the liquid P is supplied from the liquid chamber 103 to the nozzle holes 101 through the first groove 41. These points are different from the liquid discharge apparatus 100 according to the first embodiment.

As the first groove 41 is arranged on the end face 104a of the valve 104, the nozzle hole 101 is blocked by the end face 104a of the valve 104. Even if the nozzle hole 101 is closed and the gap G0 in FIG. 3 is not present between the valve 104 and the nozzle plate 102, the liquid P in the liquid chamber 103 can flow to the nozzle hole 101 through the first groove 41. In other words, even if an end of the valve 104 is at a position Q2, the liquid P in the liquid chamber 103 can flow to the nozzle hole 101 through the first groove 41. Due to such a configuration, in the liquid discharge apparatus 100 according to the first modification, when the liquid P is not to be discharged, the liquid P is supplied from the liquid chamber 103 to the nozzle holes 101, but the liquid P is not discharged from the nozzle holes 101. When the liquid P remaining in the nozzle holes 101 is exposed to the outside air and dried, the liquid P that is fresh is supplied from the liquid chamber 103 to the nozzle holes 101. Accordingly, the chances of the liquid P, which remains in the nozzle holes 101, thickening or adhering to, for example, the inner walls of the nozzle holes 101 can be reduced. As descried above, when the liquid P is discharged from the nozzle holes 101 again after a non-discharge period, the chances of discharge abnormality in which the liquid P is not discharged or the liquid P is turned and discharged can be reduced.

In the liquid discharge apparatus 100 according to the first modification, when the liquid P is not to be discharged, the gap G0 in FIG. 3 may be present. In other words, it is not necessary for the end of the valve 104 to be at the position Q2, and the end of the valve 104 may be displaced from the position Q2. The first groove 41 is not limited to the groove that extends in one direction as illustrated in FIG. 7. For example, the first groove 41 may include a plurality of grooves that intersect with each other, or may include a plurality of grooves extending radially from the center of the end face 104a. The direction in which the liquid P is discharged from the nozzle hole 101 may vary depending on the shape of the first groove 41. For this reason, from the viewpoint of reducing the influence of the shape of the first groove 41 on the direction in which the liquid P is discharged from the nozzle hole 101, it is desired that the first groove 41 has point symmetry with respect to the center of the end face 104a.

### Second Modification

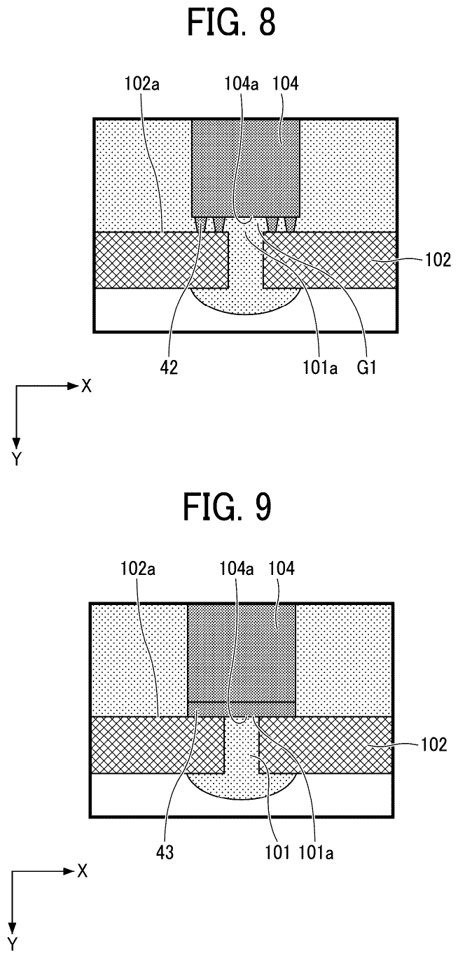

FIG. 8 is a schematic sectional view of the valve 104 provided for the liquid discharge apparatus 100 according to a second modification of the first embodiment.

FIG. 8 is a magnified view of a region corresponding to the region II in FIG. 1.

In the liquid discharge apparatus 100 according to the second modification, first convex portions 42 are arranged on the end face 104a of the valve 104. In the liquid discharge apparatus 100 according to the second modification, when the liquid P is not discharged, the liquid P is supplied from the liquid chamber 103 to the nozzle holes 101 through a first gap G1 formed as the first convex portion 42 contacts the nozzle plate 102. These points are different from the liquid discharge apparatus 100 according to the first embodiment.

As the first convex portions 42 are arranged on the end face 104a of the valve 104, the nozzle hole 101 is blocked by the end face 104a of the valve 104, and the nozzle hole 101 is closed. In other words, even when the gap G0 in FIG. 3 is absent, the liquid P in the liquid chamber 103 can flow to the nozzle hole 101 through the first gap G1. In other words, even if an end of the valve 104 is at the position Q2, the liquid P in the liquid chamber 103 can flow to the nozzle hole 101 through the first gap G1. Due to such a configuration, in the liquid discharge apparatus 100 according to the second modification, when the liquid P is not to be discharged, the liquid P is supplied from the liquid chamber 103 to the nozzle holes 101, but the liquid P is not discharged from the nozzle holes 101. When the liquid P remaining in the nozzle holes 101 is exposed to the outside air and dried, the liquid P that is fresh is supplied from the liquid chamber 103 to the nozzle holes 101. Accordingly, the chances of the liquid P, which remains in the nozzle holes 101, thickening or adhering to, for example, the inner walls of the nozzle holes 101 can be reduced. As descried above, when the liquid P is discharged from the nozzle holes 101 again after a non-discharge period, the chances of discharge abnormality in which the liquid P is not discharged or the liquid P is turned and discharged can be reduced.

In the liquid discharge apparatus 100 according to the second modification, when the liquid P is not to be discharged, the gap G0 in FIG. 3 may be present. In the liquid discharge apparatus 100 according to the second modification, when the liquid P is not discharged, the amount of the liquid P supplied from the liquid chamber 103 to the nozzle holes 101 may be changed depending on the shape of the first convex portions 42 or the positions at which the first convex portions 42 are arranged.

A shape that corresponds to the first convex portion 42 may be formed on a metal mold, and the valve 104 may be molded using the above metal mold to form the first convex portion 42. A concave portion may be formed on the valve 104 by, for example, cutting, sandblasting, etching, and embossing, to form the first convex portion 42. Alternatively, a member that makes up the first convex portion 42 may be fixed to the end face 104a of the valve 104 to arrange the first convex portion 42. Alternatively, hard particles such as aluminum oxide may be spread out onto the end face 104a of the valve 104 and then such spread hard particles may be coated to arrange the first convex portion 42. Further, the valve 104 may be formed of an elastic material, and hard particles such as aluminum oxide may be strongly pressed against the valve 104 for fixation to arrange the first convex portion 42.

### Third Modification

FIG. 9 is a schematic sectional view of the valve 104 provided for the liquid discharge apparatus 100 according to a third modification of the first embodiment.

FIG. 9 is a magnified view of a region corresponding to the region II in FIG. 1.

In the liquid discharge apparatus 100 according to the third modification, the end face 104a of the valve 104 has a first porous structure 43. In the liquid discharge apparatus 100 according to the third modification, when the liquid P is not to be discharged, the liquid P is supplied to the nozzle holes 101 through a pore of the first porous structure 43. These points are different from the liquid discharge apparatus 100 according to the first embodiment.

As the end face 104a of the valve 104 has the first porous structure 43, the nozzle hole 101 is blocked by the end face 104a of the valve 104, and the nozzle hole 101 is closed. In other words, even when the gap G0 in FIG. 3 is absent, the liquid P in the liquid chamber 103 can flow to the nozzle hole 101 through a pore of the first porous structure 43. In other words, even if an end of the valve 104 is at the position Q2, the liquid P in the liquid chamber 103 can flow to the nozzle hole 101 through a pore of the first porous structure 43. Due to such a configuration, in the liquid discharge apparatus 100 according to the third modification, when the liquid P is not to be discharged, the liquid P is supplied from the liquid chamber 103 to the nozzle holes 101, but the liquid P is not discharged from the nozzle holes 101. When the liquid P remaining in the nozzle holes 101 is exposed to the outside air and dried, the liquid P that is fresh is supplied from the liquid chamber 103 to the nozzle holes 101. Accordingly, the chances of the liquid P, which remains in the nozzle holes 101, thickening or adhering to, for example, the inner walls of the nozzle holes 101 can be reduced. As descried above, when the liquid P is discharged from the nozzle holes 101 again after a non-discharge period, the chances of discharge abnormality in which the liquid P is not discharged or the liquid P is turned and discharged can be reduced.

In the liquid discharge apparatus 100 according to the third modification, when the liquid P is not to be discharged, the gap G0 in FIG. 3 may be present. The first porous structure 43 may be formed of, for example, metallic material or resin material that has porous properties. A member that has the first porous structure 43 may be prepared as a separate body from the body of the valve 104, and the body of the valve 104 and the member having the first porous structure 43 may be bonded together to form the valve 104. The size of the pore of the first porous structure 43 may be changed to change the amount of the liquid P supplied from the liquid chamber 103 to the nozzle holes 101 when the liquid P is not discharged.

### Fourth Modification

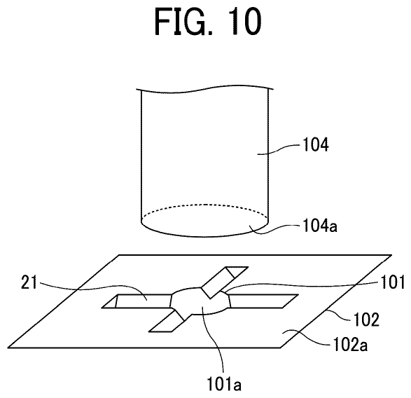

FIG. 10 is a schematic sectional view of the nozzle plate 102 provided for the liquid discharge apparatus 100 according to a fourth modification of the first embodiment.

More specifically, FIG. 10 illustrates the end face 104a of the valve 104 and the nozzle hole 101 and nozzle plate 102 that face the end face 104a.

In the liquid discharge apparatus 100 according to the fourth modification, a second groove 21 is arranged top face 102a of the nozzle plate 102, when viewed in a direction of the normal to the nozzle plate 102, which is parallel to, for example, the Y-axis direction, at least some of the second groove 21 is at a position outside the valve 104. In the liquid discharge apparatus 100 according to the fourth modification, when the liquid P is not to be discharged, the liquid P is supplied from the liquid chamber 103 to the nozzle holes 101 through the second groove 21. These points are different from the liquid discharge apparatus 100 according to the first embodiment.

AS the second groove 21 is arranged top face 102a of the nozzle plate 102, the nozzle hole 101 is blocked by the end face 104a of the valve 104, and the nozzle hole 101 is closed. In other words, even when the gap G0 in FIG. 3 is absent, the liquid P in the liquid chamber 103 can flow to the nozzle hole 101 through a pore of the first porous structure 43. In other words, even if an end of the valve 104 is at the position Q2, the liquid P in the liquid chamber 103 can flow to the nozzle hole 101 through the second groove 21. Due to such a configuration, in the liquid discharge apparatus 100 according to the fourth modification, when the liquid P is not to be discharged, the liquid P is supplied from the liquid chamber 103 to the nozzle holes 101, but the liquid P is not discharged from the nozzle holes 101. When the liquid P remaining in the nozzle holes 101 is exposed to the outside air and dried, the liquid P that is fresh is supplied from the liquid chamber 103 to the nozzle holes 101. Accordingly, the chances of the liquid P, which remains in the nozzle holes 101, thickening or adhering to, for example, the inner walls of the nozzle holes 101 can be reduced. As descried above, when the liquid P is discharged from the nozzle holes 101 again after a non-discharge period, the chances of discharge abnormality in which the liquid P is not discharged or the liquid P is turned and discharged can be reduced.

In the liquid discharge apparatus 100 according to the fourth modification, when the liquid P is not to be discharged, the gap G0 in FIG. 3 may be present. The second grooves 21 illustrated in FIG. 10 include two or more grooves that intersect with each other. However, no limitation is intended thereby, and the second groove 21 may include, for example, one groove that extends in one direction or a plurality of grooves that extend radially around the nozzle hole 101. The direction in which the liquid P is discharged from the nozzle hole 101 may vary depending on the shape of the second groove 21. For this reason, from the viewpoint of reducing the influence of the shape of the second groove 21 on the direction in which the liquid P is discharged from the nozzle hole 101, it is desired that the second groove 21 has point symmetry with respect to the nozzle hole 101.

### Fifth Modification

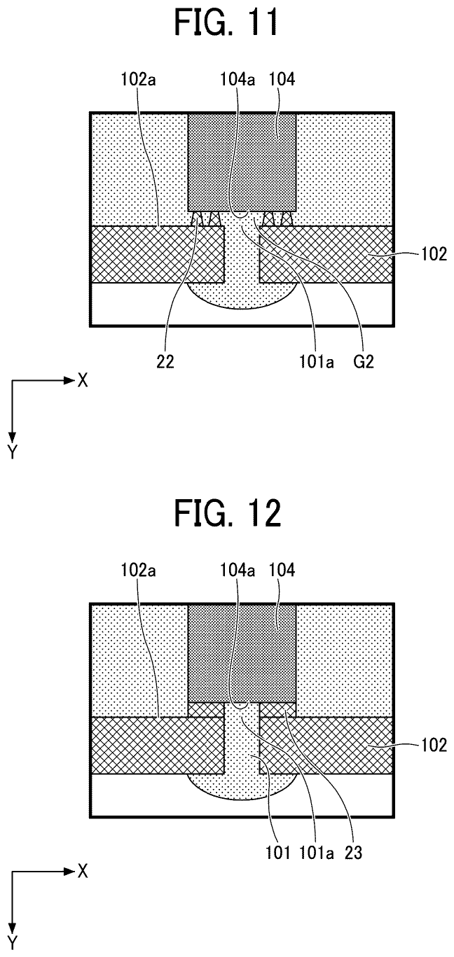

FIG. 11 is a schematic sectional view of the nozzle plate 102 provided for the liquid discharge apparatus 100 according to a fifth modification of the first embodiment. FIG. 11 is a magnified view of a region corresponding to the region II in FIG. 1.

In the liquid discharge apparatus 100 according to the fifth modification, the second convex portion 22 is arranged on a part of the top face 102a of the nozzle plate 102. In the liquid discharge apparatus 100 according to the fifth modification, when the liquid P is not discharged, the liquid P is supplied from the liquid chamber 103 to the nozzle holes 101 through a second gap G2 formed as the second convex portion 22 contacts the valve 104. These points are different from the liquid discharge apparatus 100 according to the first embodiment.

AS the second convex portion 22 is arranged on the top face 102a of the nozzle plate 102, the nozzle hole 101 is blocked by the end face 104a of the valve 104, and the nozzle hole 101 is closed. In other words, even when the gap G0 in FIG. 3 is absent, the liquid P in the liquid chamber 103 can flow to the nozzle hole 101 through the second gap G2. In other words, even if an end of the valve 104 is at the position Q2, the liquid P in the liquid chamber 103 can flow to the nozzle hole 101 through the second gap G2. In the present embodiment, the second convex portion 22 contacts the valve 104 at the position Q2. Due to such a configuration, in the liquid discharge apparatus 100 according to the fifth modification, when the liquid P is not to be discharged, the liquid P is supplied from the liquid chamber 103 to the nozzle holes 101, but the liquid P is not discharged from the nozzle holes 101. When the liquid P remaining in the nozzle holes 101 is exposed to the outside air and dried, the liquid P that is fresh is supplied from the liquid chamber 103 to the nozzle holes 101. Accordingly, the chances of the liquid P, which remains in the nozzle holes 101, thickening or adhering to, for example, the inner walls of the nozzle holes 101 can be reduced. As descried above, when the liquid P is discharged from the nozzle holes 101 again after a non-discharge period, the chances of discharge abnormality in which the liquid P is not discharged or the liquid P is turned and discharged can be reduced.

In the liquid discharge apparatus 100 according to the fifth modification, when the liquid P is not to be discharged, the gap G0 in FIG. 3 may be present. In the liquid discharge apparatus 100 according to the fifth modification, the amount of the liquid P supplied from the liquid chamber 103 to the nozzle holes 101 when the liquid P is not to be discharged may be changed depending on the shape or size of the second convex portions 22 or the positions at which the second convex portions 22 are arranged.

The second convex portion 22 can be formed on the nozzle plate 102 by, for example, cutting, sandblasting, etching, or embossing. Alternatively, a member that makes up the second convex portion 22 may be fixed to the top face 102a of the nozzle plate 102 to arrange the second convex portion 22. Alternatively, hard particles such as aluminum oxide are spread out onto the top face 102a of the nozzle plate 102 and then such spread hard particles may be coated to arrange the second convex portion 22. Further, the nozzle plate 102 may be formed of an elastic material, and hard particles such as aluminum oxide may be strongly pressed against the nozzle plate 102 for fixation to arrange the second convex portion 22.

When the second convex portion 22 is arranged on a part of the top face 102a of the nozzle plate 102, it is desired that the second convex portion 22 be absent near the nozzle hole. In other words, it is desired that, on the top face 102a of the nozzle plate 102, an area free of the second convex portion 22 be arranged between the nozzle hole 101 and an area in which the second convex portion 22 is formed. As no convex portion is present near the nozzle hole, the roundness of the edge of the nozzle hole into which the liquid flows can be maintained, and the liquid can appropriately be discharged.

### Sixth Modification

FIG. 12 is a schematic sectional view of the nozzle plate 102 provided for the liquid discharge apparatus 100 according to a sixth modification of the first embodiment.

FIG. 12 is a magnified view of a region corresponding to the region II in FIG. 1.

The liquid discharge apparatus 100 according to the sixth modification has a second porous structure 23 on a part of the top face 102a of the nozzle plate 102. In the liquid discharge apparatus 100 according to the sixth modification, when the liquid P is not to be discharged, the liquid P is supplied to the nozzle holes 101 through a pore of the second porous structure 23. These points are different from the liquid discharge apparatus 100 according to the first embodiment.

As the top face 102a of the nozzle plate 102 has the second porous structure 23, the nozzle hole 101 is blocked by the end face 104a of the valve 104, and the nozzle hole 101 is closed. In other words, even when the gap G0 in FIG. 3 is absent, the liquid P in the liquid chamber 103 can flow to the nozzle hole 101 through a pore of the second porous structure 23. In the present embodiment, the second porous structure 23 contacts the valve 104 at the position Q2. Due to such a configuration, in the liquid discharge apparatus 100 according to the sixth modification, when the liquid P is not to be discharged, the liquid P is supplied from the liquid chamber 103 to the nozzle holes 101, but the liquid P is not discharged from the nozzle holes 101. When the liquid P remaining in the nozzle holes 101 is exposed to the outside air and dried, the liquid P that is fresh is supplied from the liquid chamber 103 to the nozzle holes 101. Accordingly, the chances of the liquid P, which remains in the nozzle holes 101, thickening or adhering to, for example, the inner walls of the nozzle holes 101 can be reduced. As descried above, when the liquid P is discharged from the nozzle holes 101 again after a non-discharge period, the chances of discharge abnormality in which the liquid P is not discharged or the liquid P is turned and discharged can be reduced.

In the liquid discharge apparatus 100 according to the sixth modification, it is not always necessary for the gap G0 in FIG. 3 to be absent when the liquid P is not to be discharged. In other words, it is not always necessary for the end of the valve 104 to be at the position Q2, and the gap G0 in FIG. 3 may be present. The second porous structure 23 may be formed of, for example, metallic material or resin material that has porous properties. A member that has second porous structure 23 may be prepared as a separate body from the body of the nozzle plate 102, and the body of the nozzle plate 102 and the member having the second porous structure 23 may be bonded together to form the nozzle plate 102. The size of the pore of the second porous structure 23 may be changed to change the amount of the liquid P supplied from the liquid chamber 103 to the nozzle holes 101 when the liquid P is not to be discharged.

### Seventh Modification

When the valve conveyor 105 includes a piezoelectric element, the amount of movement of the valve 104 for the driving voltage per unit voltage may change depending on the temperature. When the total number of times the valve conveyor 105 has expanded and contracted increases, the amount of movement of the valve 104 for the driving voltage per unit voltage may decrease.

In the liquid discharge apparatus 100 according to the seventh modification, the second voltage E2 illustrated in FIG. 5 to be applied to the valve conveyor 105 when the liquid P is not to be discharged is corrected in accordance with the temperature of the valve conveyor 105 or the total number of times the valve conveyor 105 has expanded and contracted. Accordingly, the amount of the liquid P supplied to the nozzle holes 101 when the liquid P is not to be discharged is stabilized.

### Eighth Modification

In the liquid discharge apparatus 100 according to the eighth modification, the controller 120 may further control the valve conveyor 105 to move the valve 104, switching the first mode or the second mode to a third mode used not to supply the liquid P to the nozzle hole 101. In the second mode, the end face 104a of the valve 104 may be separate from the top face 102a of the nozzle plate 102 by a third distance shorter than the second distance D2, and may contact the top face 102a of the nozzle plate 102.

If the liquid P is supplied from the liquid chamber 103 to the nozzle holes 101, it may become difficult to clean, for example, the nozzle hole 101 or the nozzle plate 102. In the liquid discharge apparatus 100 according to the eighth modification, when, for example, the nozzle hole 101 or the nozzle plate 102 is to be cleaned, the third mode is selected such that the liquid P is not supplied from the liquid chamber 103 to the nozzle holes 101. This enables easy cleaning.

### Ninth Modification

In the liquid discharge apparatus 100 according to the ninth modification, the controller 120 switches between the second mode and the third mode at prescribed time intervals or predetermined length of time. By switching between the second mode and the third mode at prescribed time intervals, the amount of the liquid P supplied from the liquid chamber 103 to the nozzle holes 101 when the liquid P is not to be discharged can be adjusted.

The degree of hermetically sealing of the nozzle hole 101 by the valve 104 may change due to, for example, the changes over time on the valve 104, and the amount of the liquid P to be supplied from the liquid chamber 103 to the nozzle holes 101 may vary. In such cases, in the liquid discharge apparatus 100 according to the ninth modification, the mode is switched between the second mode and the third mode at prescribed time intervals to adjust the amount of the liquid P supplied from the liquid chamber 103 to the nozzle holes 101 when the liquid P is not to be discharged, in accordance with the changes in the degree of hermetically sealing of the nozzle hole 101 by the valve 104. Accordingly, the amount of the liquid P supplied to the nozzle holes 101 when the liquid P is not to be discharged is stabilized. The amount of the liquid P to be supplied can be controlled by the length of time for which the distance between the end face 104a and the top face 102a is controlled to the second distance D2 or the time interval of the control. Due to such a configuration, the amount of the liquid P to be supplied can be controlled with a high degree of precision. The control of the gap by the driving voltage may have a relatively large variations in the amount of the liquid to be supplied. When the gaps are to be controlled by the driving voltage for multiple nozzles, fine adjustment for the voltage is to be performed for each nozzle, and the circuitry becomes complicated and expensive. By contrast, the adjustable of the time and interval can be programmed, and detailed adjustment for the voltage is not necessary for each nozzle. Although the voltage is to be adjusted for each mode, simple circuitry and a low production cost can be achieved.

### Tenth Modification

For example, as the steam pressure around the nozzle hole 101 is higher, the amount of evaporation from the nozzle hole 101 increases. In a similar manner, as the steam pressure around the nozzle hole 101 is lower, the amount of evaporation from the nozzle hole 101 decreases.

In the liquid discharge apparatus 100 according to the tenth modification, the controller 120 may control the amount of the liquid P supplied from the liquid chamber 103 to the nozzle holes 101 when the liquid P is not to be discharged to increase as the vapor pressure around the nozzle hole 101 is higher, and may control that amount to decrease as the steam pressure around the nozzle hole 101 is lower. Due to such a configuration, when the steam pressure around the nozzle hole 101 changes, the amount of the liquid P supplied from the liquid chamber 103 to the nozzle holes 101 when the liquid P is not to be discharged is maintained at a desired degree.

### Other Modifications

When the valve conveyor 105 is fixed to the frame 106, the distance between the end face 104a of the valve 104 and the top face 102a of the nozzle plate 102 may be made equivalent to the gap G0. By so doing, the gap G0 can easily be obtained.

When the liquid P in which particles are dispersed is used, the second distance D2 may be equal to or shorter than the maximum diameter of the particles, and it is desired that the second distance D2 be equal to or shorter than the median diameter of the particles. For example, if particles flow from the liquid chamber 103 into the nozzle holes 101 when the liquid P is not to be discharged, such particles may adhere to the nozzle holes 101, and the chances of discharge abnormality may increase. By making the second distance D2 equal to or shorter than the maximum diameter of the particles, when the liquid P is not to be discharged, the particles can be prevented from flowing from the liquid chamber 103 into the nozzle holes 101. Accordingly, discharge abnormality due to the adhesion of particles to the nozzle holes 101 can be reduced. When the second distance D2 be equal to or shorter than the median diameter of the particles, discharge abnormality can further be reduced.

The liquid chamber 103 is not limited to the common chamber as illustrated in FIG. 1 where multiple liquid chambers are coupled to each other, and may be a plurality of individual liquid chambers that are separated from each other. The liquid discharge apparatus 100 is not limited to a liquid discharge apparatus having a plurality of nozzle holes 101, and as will be described later in detail, may be a liquid discharge apparatus with a single nozzle hole 101. Such a liquid discharge apparatus with a single nozzle hole may be referred to as a single-nozzle liquid discharge apparatus.

### Second Embodiment

A liquid discharge apparatus 100a according to a second embodiment is described below. In the description given below with reference to the drawings, identical or similar reference signs denote like elements, and overlapping description may be simplified or omitted as appropriate. The same condition applies to the embodiments described below.

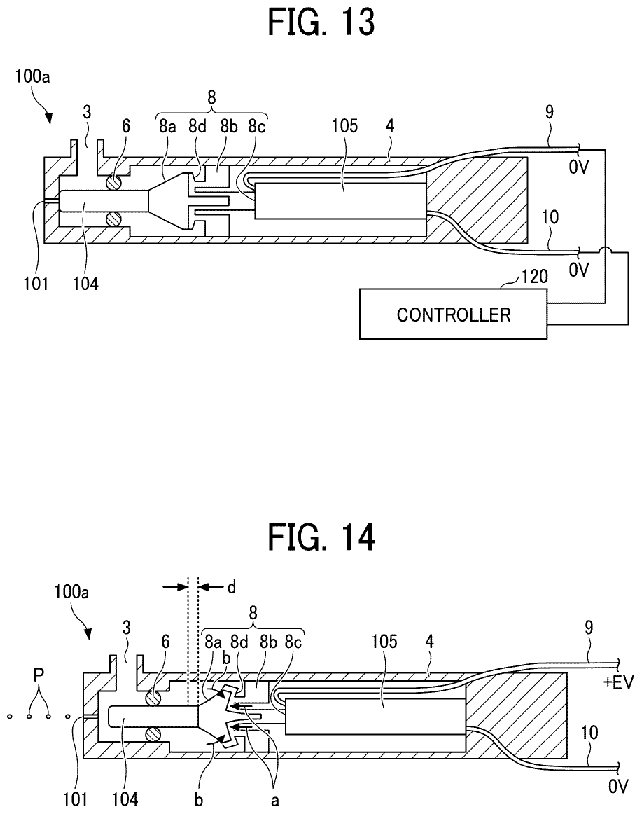

The configuration or structure of a liquid discharge apparatus 100a according to a second embodiment is described below with reference to FIG. 13 and FIG. 14.

FIG. 13 is a schematic sectional view of the liquid discharge apparatus 100a according to the second embodiment, where liquid P is not discharged.

FIG. 14 is a schematic sectional view of the liquid discharge apparatus 100a according to the second embodiment, where liquid P is discharged.

The liquid discharge apparatus 100a discharges the liquid P using a single nozzle. The liquid discharge apparatus 100a includes a nozzle housing 4, the nozzle hole 101, the valve 104, the valve conveyor 105, a reverse spring mechanism 8, a sealing member 6, a pair of lead wires 9, and a lead wire 10.

The nozzle housing 4 has the nozzle hole 101 through which the liquid P is discharged to the front end, and has an inlet 3 through which the liquid P is injected near the nozzle hole 101. The valve conveyor 105 is built in the nozzle housing 4, and expands and contracts in response to the external application of a driving voltage. The valve 104 opens and closes the nozzle hole 101. The reverse spring mechanism 8 is arranged between the valve 104 and the valve conveyor 105. The sealing member 6 is fitted on the valve 104 to prevent the liquid P from flowing into the area on the valve conveyor 105 side. The pair of lead wires 9 and the lead wire 10 are coupled to the electrodes of the valve conveyor 105 and used to apply a voltage.

As a whole, the nozzle housing 4 is formed in a cylindrical shape or an angularly cylindrical shape, and is closed except for the nozzle hole 101 and the inlet 3. The nozzle hole 101 is an opening formed at a front end of the nozzle housing 4 through which the liquid P is discharged. The inlet 3 is arranged on a side face of the nozzle housing 4 near the nozzle hole 101, and is coupled to a liquid storage. Moreover, through the inlet 3, the liquid P is continuously supplied to liquid discharge apparatus 100a by a biasing member.

The valve conveyor 105 is formed of, for example, zirconia ceramics, and is formed with an appropriate external shape and thickness in accordance with, for example, the amount of the liquid P to be discharged. The valve conveyor 105 is controlled by the driving voltage sent by the controller 120.

The sealing member 6 is, for example, a packing, a gasket, or an O-ring, and the sealing member 6 is fitted on the valve 104 to prevent the ink from flowing into the area on the valve conveyor 105 side from the area on the inlet 3 side.

The reverse spring mechanism 8 is an elastic member formed by molding, for example, deformable rubber, soft resin, or thin metallic plate as desired. The reverse spring mechanism 8 includes a deforming portion 8a whose cross section is approximately shaped like a trapezoid, a fixed portion 8b fixed to the inner wall of the nozzle housing 4, and a guide unit 8c coupled to an end face of the valve conveyor 105. The deforming portion 8a is formed so as to contact a face of the valve 104 on its base end side. The long side, i.e., the base, of the deforming portion 8a that is trapezoidal-shaped is a bent side 8d coupled to the fixed portion 8b.

When the driving voltage is applied to the valve conveyor 105, the valve conveyor 105 expands. Accordingly, in the reverse spring mechanism 8, the guide unit 8c moves toward the nozzle hole 101 to press a portion of the bent side 8d of the deforming portion 8a around the center. As a result, the apex of the deforming portion 8a, i.e., the top base of the trapezoid, which is coupled to the valve 104, moves toward the valve conveyor 105. The valve 104 is pulled toward the valve conveyor 105 by a distance d as illustrated in FIG. 13 to release the nozzle holes 101.

The distance between the bent side 8d and the apex of the deforming portion 8a of the reverse spring mechanism 8, which is a coupler with the valve 104, is adjusted, or the length of the bent side 8d is adjusted as desired. By so doing, the length of the movement of the valve 104 is made longer than the length of the expansion of the valve conveyor 105. In other words, the reverse spring mechanism 8 can amplify a slight expansion of the valve conveyor 105. Accordingly, the length of the valve conveyor 105, which is expensive, can be shortened, and the production cost of the liquid discharge apparatus 100 can significantly be reduced. For example, the moving distance of the valve 104 may be made twice as much as the moving distance of an end face of the valve conveyor 105 to shorten the length of the valve conveyor 105.

When no driving voltage is applied to the valve conveyor 105, the valve conveyor 105 returns to its original shape. For this reason, no force is externally applied to the reverse spring mechanism 8, and no deformation takes place. By contrast, when the driving voltage is applied to the valve conveyor 105, the valve conveyor 105 expands, and the guide unit 8c of the reverse spring mechanism 8 moves toward the nozzle hole 101 accordingly. As a result, the deforming portion 8a deforms as if it is squeezed.

The liquid discharge apparatus 100 and the liquid discharging method are applicable to the liquid discharge apparatus 100a with a single nozzle as described above with reference to FIG. 13 and FIG. 14, and advantageous effects similar to those of the liquid discharge apparatus 100 and the liquid discharging method according to the first embodiment can be achieved.

### Third Embodiment

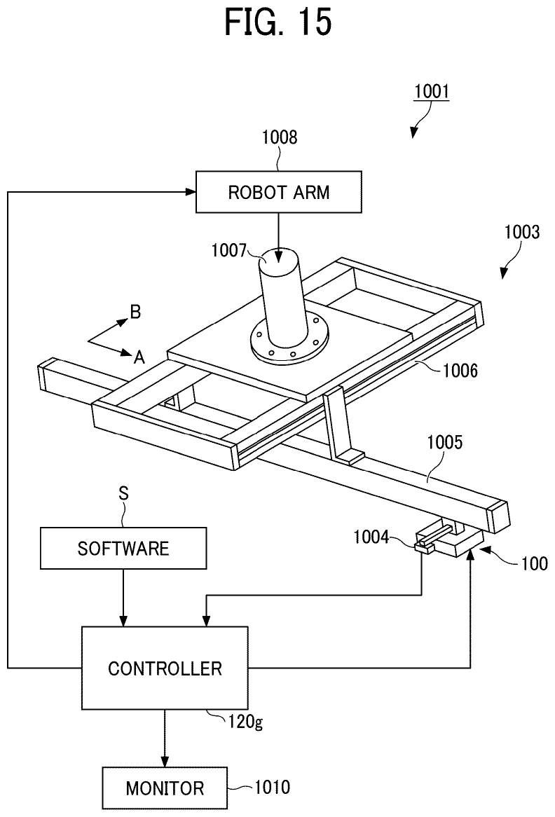

FIG. 15 is a diagram illustrating a configuration of an applicator 1001 according to a third embodiment.

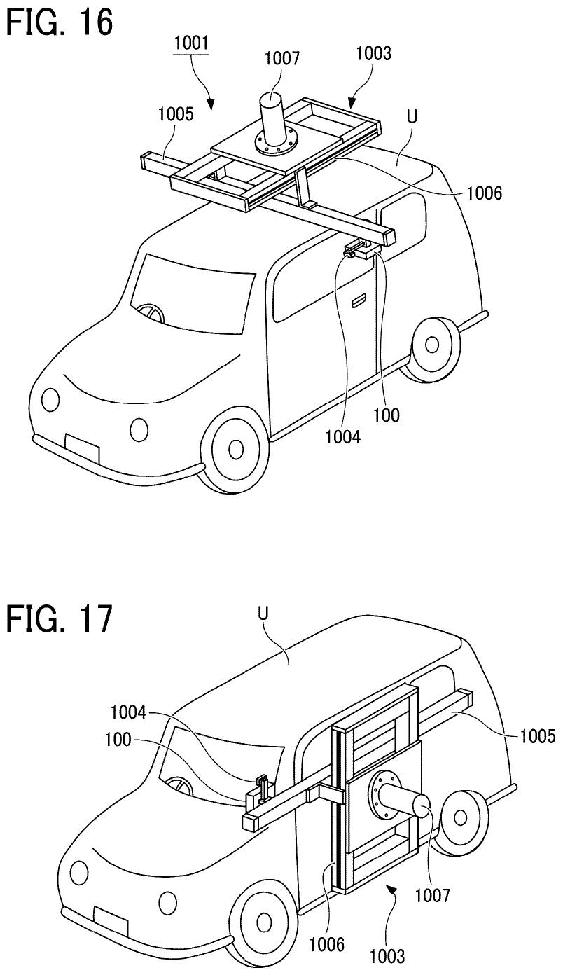

FIG. 16 is a diagram illustrating a first example of the arrangement of the applicator 1001 on an object U, according to the third embodiment.

FIG. 17 is a diagram illustrating a second example of the arrangement of the applicator 1001 on the object U, according to the third embodiment.

The applicator 1001 includes the liquid discharge apparatus 100, a camera 1004 that is an example of an imaging device arranged near the liquid discharge apparatus 100, an A-B table 1003 that moves the liquid discharge apparatus 100 and the camera 1004 in an A direction and a B direction, image and photo editing software S used to edit the images captured by the camera 1004, and a controller 120g. The controller 120g controls the A-B table 1003 to operate based on a predetermined control program, and causes the liquid P to be discharged from the liquid discharge apparatus 100. The applicator 1001 can apply the liquid P discharged from the liquid discharge apparatus 100 to the object U.

In the liquid discharge apparatus 100, the liquid P is discharged from the nozzle holes 101 toward a surface of the object U to which liquid is to be applied. The liquid P is discharged from the nozzle holes 101 in a direction orthogonal to an A-B plane. The directions in which the liquid P is discharged from each of the nozzle holes 101 are parallel to each other. For example, the distance between the nozzle hole 101 and the surface of the object U to which liquid is to be applied is about 20 cm.

The A-B table 1003 include an A-axis 1005 formed with a linear movement mechanism and a B-axis 1006 that moves the A-axis 1005 in the Y-axis direction while holding the A-axis 1005 with two arms. The liquid discharge apparatus 100 and the camera 1004 are attached to a slider. The B-axis 1006 is provided with a shaft 1007. The shaft 1007 is held by a robot arm 1008. Due to such a configuration, the liquid discharge apparatus 100 can freely be arranged to any position with respect to the object U.

For example, when the object U is an automobile, the liquid discharge apparatus 100 may be arranged above the object U as illustrated in FIG. 16, or the liquid discharge apparatus 100 may be arranged beside the object U as illustrated in FIG. 17. The controller 120g controls the operation of the robot arm 1008 based on a prescribed program.

The camera 1004 is mounted on the slider of the A-axis 1005 near the liquid discharge apparatus 100, and captures, at certain minute intervals, an image of a prescribed range on the surface of the object U to which liquid is to be applied while moving in the A direction or the B direction. The camera 1004 is, for example, a digital camera. In the camera 1004, the specification of, for example, a lens or resolution is selected as desired to enable the capturing of a plurality of subdivided images obtained by dividing the prescribed range of the surface to which liquid is to be applied. The camera 1004 continuously and automatically captures a plurality of subdivided images of the surface to which liquid is to be applied, in accordance with a program stored in the controller 120g in advance.

As described above, the applicator 1001 includes the liquid discharge apparatus 100. Due to such a configuration, for example, even if the distance between the object U and the nozzle hole 101 is long, the liquid P can be applied to a desired position of the object U with a high degree of precision. As the liquid discharge apparatus 100 can discharge the liquid P with high stability, the applicator 1001 can highly precisely coat the object U with the liquid P. The applicator 1001 may include the liquid discharge apparatus 100a in place of the liquid discharge apparatus 100 or in addition to the liquid discharge apparatus 100.

The particles that the liquid P discharged by the applicator 1001 contains are, for example, aluminum flakes, mica, or titanium oxide. The liquid P that is discharged by the applicator 1001 is a liquid such as acetone and that easily evaporates, and when the concentration of the particles in the liquid remaining in the discharge orifice increases due to the evaporation while the liquid is not discharged, the stability when the liquid P is to be discharged again may decrease. With the adoption of a configuration or structure according to the embodiments of the present disclosure, the concentration of the liquid remaining in the discharge orifice can be prevented from increasing.

Note that numerous additional modifications and variations are possible in light of the above teachings. It is therefore to be understood that within the scope of the appended claims, the disclosure of the present disclosure may be practiced otherwise than as specifically described herein. For example, elements and/or features of different illustrative embodiments may be combined with each other and/or substituted for each other within the scope of this disclosure and appended claims.

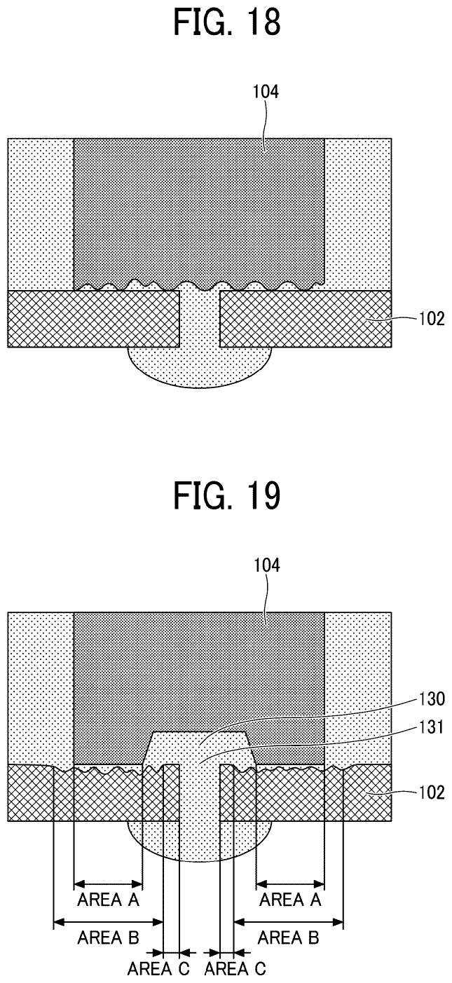

FIG. 18 is a first schematic sectional view of the nozzle plate 102 provided for the liquid discharge apparatus 100 according to a seventh modification.

FIG. 19 is a second schematic sectional view of the nozzle plate 102 provided for the liquid discharge apparatus 100 according to the seventh modification.

On the top face of the nozzle plate 102 that faces the valve 104, an area free of the second convex portion 22 may be arranged between the nozzle hole 101 and an area in which the second convex portion 22 is formed.

For example, the surface of the valve 104 at the front end may be made uneven by, for example, sandblasting, etching, and embossing. By so doing, channels for the liquid are formed. Alternatively, the surface of the nozzle plate 102 that faces or contacts at least the valve 104 may be made uneven by, for example, sandblasting, etching, and embossing. By so doing, channels for the liquid are formed.

The valve 104 may have a recessed end such that the inlet of the nozzle hole 101 and an area around that inlet do not contact such a recessed end of the valve 104.

In an area B of the nozzle plate 102 that contacts the valve 104, which is equal to or wider than an area A, uneven portions may be arranged by, for example, sandblasting, etching, and embossing. In an area C of the nozzle plate 102 near the inlet of the nozzle hole 101 and an area around that inlet, which does not contact a recessed end of the valve 104, it is not necessary to arrange uneven portions. With these configurations, the roundness of the edge of the nozzle hole 101 into which the liquid flows can be maintained. Due to such a configuration, an inkjet printing head in which a valve with uneven portions, which serve as channels for the liquid, opens and closes can be implemented while maintaining the straightness in discharging liquid.

When the end face 104a of the valve 104 is moved by the first distance DI to open the nozzle hole 101 in the liquid discharge apparatus according to the embodiments of the present disclosure, it is not always necessary for the nozzle hole 101 to be completely opened, and the nozzle hole 101 may partially be opened. Even if the nozzle hole 101 is partially opened, the chances of abnormally discharged can effectively be reduced. The amount of the liquid P to be discharged may be changed depending on how much the nozzle hole 101 is opened.

The numbers such as ordinal numbers and numerical values that indicates quantity are all given by way of example to describe the technologies to implement the embodiments of the present disclosure, and no limitation is indicated to the numbers given in the above description. The description as to how the elements are related to each other, coupled to each other, or connected to each other is given by way of example to describe the technologies to implement the embodiments of the present disclosure, and how the elements are related to each other, coupled to each other, or connected to each other to implement the functionality in the present disclosure is not limited thereby.

The division of blocks in the functional block diagrams is given by way of example. A plurality of blocks may be implemented as one block, or one block may be divided into a plurality of blocks. Alternatively, some functions may be moved to other blocks. The functions of a plurality of blocks that have similar functions may be processed in parallel or in a time-division manner by a single unit of hardware or software.

Each of the functions of the described embodiments of the present disclosure may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions. The processing circuit in the embodiments of the present disclosure as described above includes, for example, a device such as a processor that is programmed to execute software to implement functions, like a processor with electronic circuits, an application-specific integrated circuit (ASIC) that is designed to execute the above functions, a digital signal processor (DSP), a field-programmable gate array (FPGA), a complex programmable logic device (CPLD), and a circuit module known in the art.

With the application of the liquid discharge apparatus or the liquid discharging method according to the embodiments of the present disclosure, discharge abnormality can be reduced in liquid discharge apparatuses in which valves open and close and methods of discharging a liquid. Accordingly, the liquid discharge apparatus or the liquid discharging method according to the embodiments of the present disclosure is applicable to, for example, apparatuses for manufacturing elements such as electrochemical elements, printers with electrodes, painting or coating devices that apply discharged paint onto an object, or image forming apparatuses such as ink-jet printers as desired.

Typically, a secondary battery or an electrostatic capacitor that is an example of an electrochemical element may be used as an electrochemical element. In particular, the liquid discharge apparatus or the liquid discharging method according to the embodiments of the present disclosure is applicable to the manufacturing of lithium-ion secondary batteries. For example, with the application of the liquid discharge apparatus or the liquid discharging method according to the embodiments of the present disclosure, the period during which no liquid is discharged can significantly be extended compared with cases in which the liquid discharge apparatus and the liquid discharging method according to the embodiments of the present disclosure are not applied. More specifically, the period during which no liquid is discharged indicates a period between the time at which the discharging of the liquid P is stopped and the time at which the discharging of the liquid P starts again, and by definition, discharge abnormality does not occur when the discharging of the liquid P starts again. With the use of a rolled base to which the liquid discharge apparatus according to the embodiments of the present disclosure is applied, for example, when lithium-ion secondary batteries are manufactured, the chances of discharge abnormality can be reduced when the liquid is to be discharged again after the base whose length is 2000 m runs at 60 meters per minute (mpm) and thirty minutes have passed.

Aspects of the present disclosure are, for example, as follows.

### First Aspect

A liquid discharge apparatus includes a liquid chamber including a nozzle plate having a nozzle hole, a supply unit to supply a liquid to the liquid chamber, a valve disposed in the liquid chamber, and a valve conveyor to move the valve. When the liquid is to be discharged and when the liquid is not to be discharged, the liquid is supplied from the liquid chamber to the nozzle hole. An amount of the liquid to be supplied to the nozzle hole when the liquid is not to be discharged is smaller than an amount of the liquid to be supplied to the nozzle hole when the liquid is to be discharged.

### Second Aspect

In the liquid discharge apparatus according to the first aspect, the valve has an end face facing the nozzle plate, the end face has a first groove, and when the liquid is not discharged, the liquid is supplied from the liquid chamber to the nozzle hole through the first groove.

### Third Aspect

In the liquid discharge apparatus according to the first aspect or the second aspect, the valve has an end face facing the nozzle plate, the end face has a first convex portion, and when the liquid is not to be discharged, the liquid is supplied from the liquid chamber to the nozzle hole through a first gap formed as the first convex portion contacts the nozzle plate.

### Fourth Aspect

In the liquid discharge apparatus according to any one of the first aspect to the third aspect, the valve has an end face facing the nozzle plate, the end face has a first porous structure, and when the liquid is not to be discharged, the liquid is supplied to the nozzle hole through a pore of the first porous structure.

### Fifth Aspect

In the liquid discharge apparatus according to any one of the first aspect to the fourth aspect, the nozzle plate has a top face facing the valve, wherein the top face has a second groove, and when the liquid is not to be discharged, the liquid is supplied from the liquid chamber to the nozzle hole through the second groove.

### Sixth Aspect

In the liquid discharge apparatus according to any one of the first aspect to the fifth aspect, the nozzle plate has a top face facing the valve, the top face has a second convex portion, and when the liquid is not to be discharged, the liquid is supplied from the liquid chamber to the nozzle hole through a second gap formed as the second convex portion contacts the valve.

### Seventh Aspect

In the liquid discharge apparatus according to the sixth aspect, the nozzle plate has a top face facing the valve, and the top face has an area free of the second convex portion between the nozzle hole and an area in which the second convex portion is formed.

### Eighth Aspect

In the liquid discharge apparatus according to any one of the first aspect to the seventh aspect, the nozzle plate has a top face facing the valve, the top face has a second porous structure, and when the liquid is not to be discharged, the liquid is supplied from the liquid chamber to the nozzle hole through a pore of the second porous structure.

### Ninth Aspect

The liquid discharge apparatus according to any one of the first aspect to the eighth aspect further includes a controller to control movement of the valve by the valve conveyor. The controller uses movement of the valve by the valve conveyor to switch between a first mode used to discharge the liquid and a second mode used not to discharge the liquid. In the first mode, the valve has an end face facing the nozzle plate, the nozzle plate has a top face facing the valve, and the end face of the valve is separate from the top face of the nozzle plate by a first distance. In the second mode, the end face of the valve is separate from the top face of the nozzle plate by a second distance shorter than the first distance. In the second mode, the liquid is supplied from the liquid chamber to the nozzle hole through a space between the end face of the valve and the top face of the nozzle plate.

### Tenth Aspect

In the liquid discharge apparatus according to the ninth aspect, the controller controls the valve conveyor to move the valve, further switching the first mode or the second mode to a third mode used not to supply the liquid to the nozzle hole. In the third mode, the end face of the valve contacts the top face of the nozzle plate or is separated from the top face of the nozzle plate by a third distance shorter than the second distance.

### Eleventh Aspect

In the liquid discharge apparatus according to the tenth aspect, the controller switches between the second mode and the third mode at prescribed time intervals.

### Twelfth Aspect

A method of discharging a liquid uses a liquid discharge apparatus including a liquid chamber including a nozzle plate having a nozzle hole through which liquid is discharged, a supply unit to supply the pressurized liquid to the liquid chamber, a valve disposed in the liquid chamber, and a valve conveyor to move the valve. The liquid discharge apparatus supplies the liquid from the liquid chamber to the nozzle hole when the liquid is to be discharged and when the liquid is not to be discharged. An amount of the liquid supplied to the nozzle hole when the liquid is not to be discharged is smaller than an amount of the liquid supplied to the nozzle hole when the liquid is to be discharged.

### Thirteenth Aspect

In the method of discharging the liquid according to the twelfth aspect, the amount of the liquid to be supplied to the nozzle hole when the liquid is not to be discharged varies depending on a type of the liquid.

### Fourteenth Aspect

In the method of discharging the liquid according to the twelfth aspect or the thirteenth aspect, a controller controls movement of the valve by the valve conveyor, and the controller uses movement of the valve by the valve conveyor to switch between a first mode used to discharge the liquid and a second mode used not to discharge the liquid. In the first mode, the valve has an end face facing the nozzle plate, the nozzle plate has a top face facing the valve, and the end face of the valve is separate from the top face of the nozzle plate by a first distance. In the second mode, the end face of the valve is separate from the top face of the nozzle plate by a second distance shorter than the first distance. In the second mode, the liquid is supplied from the liquid chamber to the nozzle hole through a space between the end face of the valve and the top face of the nozzle plate.

### Fifteenth Aspect

In the method of discharging the liquid according to the fourteenth aspect, particles are dispersed to the liquid, and the second distance is equal to or shorter than a maximum diameter of the particles.

### Sixteenth Aspect

In the method of discharging the liquid according to the fourteenth aspect or the fifteenth aspect, the controller controls the valve conveyor to move the valve, further switching the first mode or the second mode to a third mode used not to supply the liquid to the nozzle hole. In the third mode, the end face of the valve is separated from the top face of the nozzle plate by a third distance shorter than the second distance or contacts the top face of the nozzle plate.

### Seventeenth aspect

In the method of discharging the liquid according to the sixteenth aspect, the controller switches between the second mode and the third mode at prescribed time intervals.

### Eighteenth Aspect

In the method of discharging the liquid according to any one of the twelfth aspect to the seventeenth aspect, when the liquid is not to be discharged, a part of the liquid disposed in the nozzle hole protrudes from the nozzle plate.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A liquid discharge apparatus comprising:
a liquid chamber including a nozzle plate having a nozzle hole;
a supply unit to supply a liquid to the liquid chamber;
a valve disposed in the liquid chamber; and
a valve conveyor to move the valve,
wherein when the liquid is to be discharged and when the liquid is not to be discharged, the liquid is supplied from the liquid chamber to the nozzle hole, and
wherein an amount of the liquid to be supplied to the nozzle hole when the liquid is not to be discharged is smaller than an amount of the liquid to be supplied to the nozzle hole when the liquid is to be discharged.

2. The liquid discharge apparatus according to claim 1,
wherein the valve has an end face facing the nozzle plate,
wherein the end face has a groove, and
wherein when the liquid is not to be discharged, the liquid is supplied from the liquid chamber to the nozzle hole through the groove.

3. The liquid discharge apparatus according to claim 1,
wherein the valve has an end face facing the nozzle plate,
wherein the end face has a convex portion, and
wherein when the liquid is not to be discharged, the liquid is supplied from the liquid chamber to the nozzle hole through a gap formed as the convex portion contacts the nozzle plate.

4. The liquid discharge apparatus according to claim 1,
wherein the valve has an end face facing the nozzle plate,
wherein the end face has a porous structure, and
wherein when the liquid is not to be discharged, the liquid is supplied to the nozzle hole through a pore of the porous structure.

5. The liquid discharge apparatus according to claim 1,
wherein the nozzle plate has a top face facing the valve,
wherein the top face has a groove, and
wherein when the liquid is not to be discharged, the liquid is supplied from the liquid chamber to the nozzle hole through the groove.

6. The liquid discharge apparatus according to claim 1,
wherein the nozzle plate has a top face facing the valve,
wherein the top face has a convex portion, and
wherein when the liquid is not to be discharged, the liquid is supplied from the liquid chamber to the nozzle hole through a gap formed as the convex portion contacts the valve.

7. The liquid discharge apparatus according to claim 6,
wherein the top face of the nozzle plate has an area free of the convex portion between the nozzle hole and an area in which the convex portion is formed.

8. The liquid discharge apparatus according to claim 1,
wherein the nozzle plate has a top face facing the valve,
wherein the top face has a porous structure, and
wherein when the liquid is not to be discharged, the liquid is supplied from the liquid chamber to the nozzle hole through a pore of the porous structure.

9. The liquid discharge apparatus according to claim 1, further comprising
a controller to control movement of the valve by the valve conveyor,
wherein the controller uses movement of the valve by the valve conveyor to switch between a first mode used to discharge the liquid and a second mode used not to discharge the liquid,
wherein in the first mode, the valve has an end face facing the nozzle plate, the nozzle plate has a top face facing the valve, and the end face of the valve is separate from the top face of the nozzle plate by a first distance,
wherein in the second mode, the end face of the valve is separate from the top face of the nozzle plate by a second distance shorter than the first distance, and
wherein in the second mode, the liquid is supplied from the liquid chamber to the nozzle hole through a space between the end face of the valve and the top face of the nozzle plate.

10. The liquid discharge apparatus according to claim 9,
wherein the controller controls the valve conveyor to move the valve, further switching the first mode or the second mode to a third mode used not to supply the liquid to the nozzle hole, and
wherein in the third mode, the end face of the valve contacts the top face of the nozzle plate or is separated from the top face of the nozzle plate by a third distance shorter than the second distance.

11. The liquid discharge apparatus according to claim 10,
wherein the controller switches between the second mode and the third mode at prescribed time intervals.

12. A method of discharging a liquid, the method comprising
supplying the liquid from a liquid chamber to a nozzle hole of a nozzle plate when the liquid is to be discharged and when the liquid is not to be discharged,
wherein an amount of the liquid to be supplied to the nozzle hole when the liquid is not to be discharged is smaller than an amount of the liquid to be supplied to the nozzle hole when the liquid is to be discharged.

13. The method according to claim 12,
wherein the amount of the liquid to be supplied to the nozzle hole when the liquid is not to be discharged varies depending on a type of the liquid.

14. The method according to claim 12, further comprising:
controlling movement of a valve disposed in the liquid chamber by a valve conveyor; and
switching between a first mode used to discharge the liquid and a second mode used not to discharge the liquid, using the movement of the valve by the valve conveyor,
wherein in the first mode, the valve has an end face facing the nozzle plate, the nozzle plate has a top face facing the valve, and the end face of the valve is separate from the top face of the nozzle plate by a first distance,
wherein in the second mode, the end face of the valve is separate from the top face of the nozzle plate by a second distance shorter than the first distance, and
wherein in the second mode, the liquid is supplied from the liquid chamber to the nozzle hole through a space between the end face of the valve and the top face of the nozzle plate.

15. The method according to claim 14,
wherein particles are dispersed to the liquid, and
wherein the second distance is equal to or shorter than a maximum diameter of the particles.

16. The method according to claim 14, further comprising
controlling the valve conveyor to move the valve, further switching the first mode or the second mode to a third mode used not to supply the liquid to the nozzle hole, and
wherein in the third mode, the end face of the valve is separated from the top face of the nozzle plate by a third distance shorter than the second distance or contacts the top face of the nozzle plate.

17. The method according to claim 16, further comprising
switching between the second mode and the third mode at prescribed time intervals.

18. The method according to claim 12,
wherein when the liquid is not to be discharged, a part of the liquid disposed in the nozzle hole protrudes from the nozzle plate.
